(19) United States
(12) Patent Application Publication
(10) Pub. No.: US 2011/0194456 A1
(43) Pub. Date: Aug. 11, 2011

(54) HYBRID COVERAGE PLANNER AND COST ESTIMATOR

(76) Inventors: Bradley S. Fordham, Atlanta, GA (US); Adam P. Walker, Lilburn, GA (US)

(21) Appl. No.: 12/703,444

(22) Filed: Feb. 10, 2010

(51) Int. Cl. H04L 12/28

(52) U.S. Cl. 370/254

(57) ABSTRACT

A dynamic network planning and cost estimation tool for designing, enhancing and deploying telecommunication networks that administers supplied definition data including service descriptions, equipment specifications and empirical network design and demographic data by storing that information and making it accessible to the tool. A user can provide a target coverage area along with some definitions related to the target area, such as services to include or exclude, equipment types to include or excludes, etc. Based on the available equipment and services, calculations are run to determine how many pieces of the equipment are required to provide full coverage, as well as meet desired throughput and data packet delivery requirements.

### BACKGROUND

The present disclosure is directed towards the field of telecommunications network planning and, more specifically, a system and method of automating telecommunication system coverage planning and cost estimation.

The telecommunications market is very competitive, complex, technology driven, feature laden, and immensely consumer and environment dependent. With the magnitudes of services and technologies available to be deployed within a telecommunications network, a telecommunications company not only has to identify the best services and technologies to deploy in a particular demographic area, but must do so in a profitable manner and in a way that will help prevent a high churn-out rate for services, attract and keep subscribers, and provide a high number and quality of profitable services.

Within the telecommunications industry—especially in the planning of new network businesses or expansion of an existing network business—there are at least six core questions which can be very difficult to answer but, nonetheless should be answered with a high degree of certainty, or at least thrown on the table for discussion, very early in the planning process. These questions are enumerated as:

1. What services should be offered to subscribers/users?

2. What technology(ies) should be used to cover a particular geographic area to enable these services?

3. What vendor(s) and vendor equipment type(s) should be employed?

4. What is a reasonable estimate of the cost to build out this coverage?

5. What is a reasonable estimate of the returns or benefits this network will produce?

6. Based on the cost and return estimates, how long will it take to see a real Return On my Investment (ROI) and how large will that return be?

Obviously, these are not the only questions that must be addressed and, the form and content of the above-enumerated questions can vary but, in general, in the planning of a new network business or expansion of an existing network business, these questions are controlling elements of what happens going forward and should be addressed in some form or another.

To increase the ability for a network owner to predictably deploy, operate, maintain, and evolve a profitable network business over time, these questions should be reviewed, studied and satisfactorily answered. It will certainly be appreciated by those skilled in the art that each of these six questions can be very difficult to answer without a large repository of past experiences and expertise, as well as automation to apply this knowledge to what is known and predict/calculate “best-fit” answers in reasonable amounts of time. This problem applies both to wired and wireless networking as well as networks that involve both wired and wireless links.

Previous Approaches and Shortcomings

Because of the problems and complexities associated with the deployment of telecommunications networks, there have been previous approaches in attempt to address these problems. These previous approaches though, have lacked automation and software decision support, as well as a firm foundation in empirical data from past experiences. As such, the network owner has been forced to ignore some or all of the above-enumerated six key questions, or answer them with less than rigorous methods of analysis. Thus, typical network owners/designers/implementers still find themselves: (a) guessing what action to take by following their gut instincts or intuition; (b) consulting available information and experts to identify at least portions of the solution in a piecemeal fashion; and/or (c) resorting to the most common method of all, that being to simply copy what some other network operation is doing under the assumption that their decisions were based on somewhat sound answers to the above-enumerated questions.

With regards to guessing what action to take based on gut instincts, the costs associated with such a risk can be detrimental and are highly unpredictable. By following such gut instincts or intuition, it is clear that on many occasions, the wrong decisions have had to have been made by looking at poor or irrelevant data and/or by not taking the time to fully analyze the situation. Also developing and acting on such instincts fails to document the full process and so in the event of any level of success or failure, the question remains as to whether lessons have been actually learned which may benefit future network deployments or expansions. As for consulting available information and other experts for portions of the solution, this results in a piecemeal approach and solution obtained by taking actions in an ad-hoc manner again without a clear record of and clear connections between the facts, the analysis, and the conclusions. Actions that may or may not have been performed and likely were not clearly recorded include adapting the information to a more specific situation/environment, assembling the partial information into more complete answers to these questions, and/or attempting to test these answers and refine them. As for resorting to copying what was done by other network operators, again significant risks are incurred in that the demographics or the physical environment of the deploying network can be significantly different from the compared networks. Also one may fail to take advantage of technology advancements that could achieve greater profitability, make decisions based on limited information about the compared network that may be available, etc.

Ignoring the above-enumerated questions or resorting to the above-listed methods for obtaining suboptimal answers to one or more of these questions most typically results in the creation of network deployments with low levels of profitability. This can be due to a variety of reasons, including but not limited to the following reasons:

1. Because of a lack of automation support, these methods tend to overlook all of the variables that should be examined to more accurately answer the above-listed key questions. (Computers and software are simply better at examining complex interactions across large numbers of variables.)

2. Ad-hoc answers to these questions tend to be very high-level, for example identifying a vendor to use but not specific model numbers of equipment, or identifying services to offer but not precise bundles of those products. (With automation support, these answers can be much more specific and precise.)

3. Hybridization, a very useful tool in defining the optimal solutions, tends not to be considered in this ad-hoc, manual response-generation for the above-listed six questions. (Automation can support more sophisticated hybridization on many levels. We could mix various services, technologies, vendors, and/or equipment types/models in order to refine our cost structure and profit opportunity.)

In addition to failing to provide adequate answers to the six key questions, the previous approaches used in the art are simply too slow. In this fast-paced world of network technologies and network business strategies, there is a need for an automated solution that can answer the above-listed questions effectively in minutes instead of months or years. Further, what is needed is a solution that can immediately refine the answers to the questions as soon as a change in the technology or business landscape is identified, detected or anticipated. Telecommunications networks, as is true with most technology-driven industries, changes very quickly. Compound this with the reality that telecommunications customers' needs and wants are constantly changing, and we can see clearly how speed is every bit as important as accuracy in this domain.

### BRIEF SUMMARY

The above-identified needs in the art, as well as other needs not identified are addressed in various embodiments of a dynamic network planner and cost estimator. Various embodiments of the dynamic network planner and cost estimator provide the functionality for the above-listed questions to be quickly and easily analyzed and answered, or any subset of them, for a network business in a fast, precise, and immediately updateable way. This is accomplished by creating and maintaining a database of relevant facts and empirically proven results based on past experiences, and providing automated calculations that can leverage that database and adapt the results to new situations in near real-time.

One embodiment of the dynamic network planning and cost estimation solution operates to receive definition data from an administrative user, the definition data including technology specifications, equipment specification and subscriber services definitions and then store the data into a memory element. The solution also receives a coverage area definition from an end user. The coverage area definition can include the identity of areas, services and equipment to include in the simulation or to exclude from the simulation. Based on the coverage area definition, applicable configuration data is extracted from the memory element. The extracted configuration data may include services or bundles of services that may be offered, or that should be offered in the coverage area based on the demographics known about the population within that area, as well as other factors. The number of pieces of each type of equipment required to deploy a network that fully services the coverage area is then calculated. This calculation can include the steps of calculating an effective radius for a particular piece of equipment, calculating an effective circumference for the particular piece of equipment; and calculating a minimum number of cells to cover the coverage area based on the number of columns and rows required in view of the effective circumference.

The solution continues by identifying the data throughput requirements for each node in the network and he required packet handling for each node in the network. The cost of the network based at least in part on the number of required pieces of the particular equipment type and the costs associated with that particular equipment type is calculated if the throughput requirements for each node in the network are less than the throughput capacity for the particular equipment type and, the required packet handling per node is less than the packet-handling capacity of the particular equipment type. However, if the throughput requirements for each node are not less than the throughput capacity for the particular equipment type and/or, the required packet handling per node is not less than the packet-handling capacity of the particular equipment type, then the effective circumference is decreased and the process is repeated with this decreased effective circumference.

### BRIEF DESCRIPTION OF THE SEVERAL VIEWS OF THE DRAWING

FIG. 1 is flow diagram illustrating general steps that may be performed in an exemplary embodiment of a calculations/simulations routine.

FIG. 2 is a flow diagram of exemplary steps performed in an exemplary coverage calculation algorithm that can be employed within an exemplary dynamic network planner and cost estimator system.

FIG. 3 is a map diagram illustrating the operation of an exemplary aggregation operation in an embodiment of the dynamic network planner and cost estimator system.

FIG. 4 is a map diagram illustrating an exemplary technique for coverage exclusion for an area with uniform demographics and service needs.

FIG. 5 is a mapping diagram illustrating how the overlay feature may appear on a mapping interface.

FIG. 6 is a block diagram illustrating a functional breakdown of various components and functions in an exemplary embodiment of a dynamic network planner and cost estimator.

### DETAILED DESCRIPTION OF EMBODIMENTS

Various embodiments of a dynamic network planner and cost estimator, as well as features and aspects thereof, is directed towards providing an auditable, automated, reliable and near real-time solution to issues that need to be addressed in the planning and deployment of telecommunication networks and generating plan optimization for deployment solutions. The various embodiments may be described as involving three operational stages, functions or sub-systems. The first is a database system that is used for housing, storing and maintaining a variety of telecommunication network design and operational information. This stage includes the collection, organization, indexing and keying of such important information, as well as the storage and maintenance of the information. The second operational stage involves dynamically generating planning and deployment estimation/optimization functions, criteria, goals, and/or objectives based on known information that is heuristically applied against the database. Finally, the design and deployment functions, criteria, goals and/or objections are then applied in the planning for the deployment of the telecommunications network, as well as the collection of operational data related to such deployments which, is then fed back into the first operational stage.

### Description of a General Embodiment

A general embodiment of a dynamic network planner and cost estimator provides a sophisticated tool that enables users across a wide variety of technical expertise levels (i.e., ranging from inexperienced, such as a network solution salesperson or a prospective network owner, to professionally trained such as a network designer), to describe the targeted geographic area(s) to be covered or serviced, as well as demographics regarding the population(s) that live in those coverage areas (potential subscribers to network services). From this information, the dynamic network planner and cost estimator can present back to this user one or more sets of “best-fit” answers to the following six telecommunications network planning/deployment questions:

1. What services should be offered to subscribers/users of the network?

2. What technology(ies) should be used to cover this area to enable these services?

3. What vendor(s) and vendor equipment type(s) should be employed?

4. What is a reasonable estimate of the cost to build out this coverage?

5. What is a reasonable estimate of the returns or benefits this network will produce?

6. Based on the cost and return estimates, how long will it take to see a real Return On Investment (ROI) and how large will that return be?

In various embodiments, the user may be able to constrain or restrict the “search space” in which the system looks for the answers to these questions. For example, the user can specify that only a subset of potential service offerings, technologies, vendors, or equipment types should be considered. This capability reflects the reality that not all options may be equally available in all parts of the world or countries, or admissible in all business situations. For instance, some equipment may be preferred in one environment and not preferred in another environment. Having this ability enables optimal solutions based on the desired or necessary user-imposed constraints to be obtained.

One purpose of the various embodiments of the dynamic network planners and cost estimators is that the embodiments may be operated to narrow down the choices of service, technology, and equipment based on suitability, and then to estimate the costs and returns for each applicable service/technology/vendor/equipment configuration in each area of coverage. Advantageously, such capabilities enable the user to more adequately consider all of the options that may be available to identify the best or optimal courses of action.

In furtherance of understanding a particular embodiment, the interactions that each type of user has with an embodiment of the dynamic network planner and cost estimator, including the inputs, the calculations, and the outputs are presented in more detail.

Users Types

There are several types of users of the dynamic network planner and cost estimator. The first user type, which is referred to as the Technology Administrator, is the technology expert equipped to configure the dynamic network planner and cost estimator with various pieces of equipment available in the global marketplace along with reasonable assumptions on their coverage capabilities. As non-limiting examples, the technology administrator may load the desired or required capabilities—in terms of technical metrics such as total bandwidth, packets-per-second, and latency—for a particular type of cable modem configuration, Wi-Fi access point, WiMAX base station, or microwave point-to-point link.

The second user type, which is referred to as the Cost Administrator, is a procurement/logistics expert (often within a local market) equipped to configure the tool with reasonable total cost assumptions (acquisition costs, transport and other logistical costs, maintenance costs, etc.) for each piece of equipment in each local market and the knowledge to exclude any pieces of equipment that cannot be obtained in a given region, or operated in a given region or environment, etc.

The third user type, which is referred to as the End User, is not required to be deeply technical because in operating the system, they are only required to:

1. Input into the dynamic network planner and cost estimator system a description of the area(s) to cover and a description of the prospective subscribers in these area(s) (i.e., demographics, etc.);

2. Punch or actuate a button or actuator to run a simulation/estimation;

3. Interpret the output results which are presented in simple business-oriented terms

System Administration

Various embodiments of a dynamic network planner and cost estimator may provide functionality for two types of administrative users (Technology Administrators and Cost Administrators). Depending on the particular user type, the administrative users collectively operate to configure the assumptions for the system and then manage the equipment and cost assumptions over time as new equipment is certified or technical specifications change, new empirical knowledge is gained through experience, and pricing, logistics, and other costs change.

It should be noted that in various embodiments, flexibility can been engineered into the dynamic network planner and cost estimator system at a number of levels to ensure that the system can adapt rapidly to changes both in the technology spaces and the business/market spaces. These flexibilities include, but are not necessarily limited to:

(a) being able to change the data-representations for the entities or objects in the system (this allows for the expansion or updating of the technical descriptors, the costing elements, the subscriber and service descriptors, and so forth); and

(b) being able to plug-in new or updated algorithms for various key calculation/estimation steps to enable or realize the benefits from new “best practices” in these estimations.

As an example, the present disclosure provides some details of the initial data representations, functionalities and/or calculations present in various embodiments of a dynamic network planner and cost estimator. Further, the various functionalities in an exemplary embodiment are described in more detail. Those skilled in the art will appreciate that not all embodiments must include all of the defined functionalities and, some embodiments may also include functionality that is not listed in this disclosure. The general data categories are provided immediately below and, a more detailed exemplary, but not limiting embodiment is illustrated in Exhibit A for purposes of clarity only.

Managing the Network Coverage Equipment

The function of managing the network coverage equipment is an administrative function where administrative users can define, update, or remove a type of coverage equipment and/or its coverage capacities as well as administer its pricing and other costing information by market. In the described embodiment, the definition of a piece of coverage equipment may include the following information presented as a non-limiting example:
vendor information;
model information;
coverage technology type;
equipment description;
coverage area radius;
suggested overlap in coverage;
client capacity;
throughput capacity;
packet-handling capacity; and
cost table including acquisition cost, tier-based cost additions and annual operational costs. (In many embodiments it is useful for these costs to be broken out by “market” which loosely defines an area of a country or the globe since costs are not expected to be the same everywhere.)

Managing the Network Backhaul Equipment

The function of managing the network backhaul equipment is an administrative function where administrative users can define, update, or remove a type of backhaul equipment and/or its data transmission. The backhaul links are higher capacity point-to-point and point-to-multipoint connections used to aggregate traffic back from the subscribers towards the core of a network. In the described embodiment, the definition of a piece of backhaul equipment may include the following information presented as a non-limiting example:
vendor information;
model information;
link type;
frequency;
equipment description;
coverage range;
coverage link count;
throughput capacity;
packet-handling capacity; and
cost table including acquisition cost and operational costs. (In many embodiments it is useful for these costs to be broken out by “market” which loosely defines an area of a country or the globe since costs are not expected to be the same everywhere.)

Managing the Additional Network Equipment

The function of managing the additional network equipment is an administrative function where administrative users can define, update, or remove a type of additional equipment and/or that an end user may specify “a la carte” as required in a coverage area. The definition of a piece of additional equipment may include the following information presented as a non-limiting example:
name information;
equipment description; and
cost table including acquisition cost and operational costs. (In many embodiments it is useful for these costs to be broken out by “market” which loosely defines an area of a country or the globe since costs are not expected to be the same everywhere.)

Managing the Network Service Assumptions

The function of managing the network service assumptions is an administrative function where administrative users can define, update, or remove a type of service and its capacity and Quality of Service (QoS) requirements. The definition of a service's requirements include, as a non-limiting example:
name of service;
service description;
throughput requirements;
packet-handling requirements;
oversubscription factor; and
cost table including setup cost and operational costs. (In many embodiments it is useful for these costs to be broken out by “market” which loosely defines an area of a country or the globe since costs are not expected to be the same everywhere.)

Managing the Cost Modifiers

The function of managing the cost modifiers is an administrative function where administrative users can define, update, or remove a number of “cost modifiers” that an end use may specify “a la carte” as applicable to a coverage area. The definition of a cost modifier includes, as a non-limiting example:
name of cost modifier;
description of cost modifier;
lookup value; and
factor for modifying cost. (In many embodiments it is useful for these costs to be broken out by “market” which loosely defines an area of a country or the globe since costs are not expected to be the same everywhere.)

Managing the System Tuning Parameters

In the various embodiments, several tuning parameters can built into the system. An administrator can initially set these tuning parameters to default values or estimated values, and then manage these tuning parameters over time to improve/optimize the performance of particular embodiments. In operation, these parameters should constantly be refined based on empirical data. In an exemplary embodiment, the tuning parameters may include:

(a) Minimum size of coverage area. This tuning parameter identifies the minimum size of a coverage area that is allowed to be configured in the system. If an area is too small, the accuracy will be lower than is acceptable because the law of averages for estimation.

(b) Maximum size of coverage area. This tuning parameter identifies the maximum size of a coverage area that is allowed to be configured in the system. If an area is too large, the end user may be better off by breaking the area down into smaller—more focused—areas to improve estimation quality.

(c) Additional parameters. Additional parameters can be incorporated into various embodiments.

Administrative User Actions

There are a number of operations, actions or functions that an Administrative User is allowed to do with the various embodiments of the dynamic network planner and cost estimator system as they act on the various data items (or objects) they can manage—equipment, environmental adjustments, etc. In an exemplary embodiment such operations, actions or functions may include:

1. Login/Logout (with role-based limitations on what the user can access)

2. Create a new item in a Market that the user is able to access (permissions controlled by the login)

3. Load an existing (previously defined) item within a Market that the user is able to access (permissions controlled by the login)

4. Save an existing item under a new/different name or into another Market this user has access to—thus allowing an area to be “copied”

5. Modify an item and save the updates including the ability to rename the item in place (no copying)

6. Search for an item that has particular characteristics, e.g. a specified market or in a particular range of cost within a market, or with certain coverage capabilities (it is assumed that this search for items is within an item type, i.e. within the set of coverage equipment or backhaul equipment or tuning parameters).

7. Access information on when this item was created and last modified and by whom (to understand by whom and when this current assumption was set up)

8. Change ownership for data objects as necessary within the system.

System Operation

The system operation describes and defines the activities for an end user, who leverages an exemplary system to estimate the requirements, costs, and potential revenues for providing selected services to subscribers in a group of coverage areas that he/she defines. The system operation includes the features or functions of (a) general end user actions, (b) defining a project, (c) defining coverage area(s), (d) calculations/simulations, (e) identifying additional coverage capabilities, (f) determining distribution and backbone, and (g) performing cost/benefit analysis and ROI

(a) General End User Actions

There are a number of general operations or actions that an End User is allowed or enabled to perform with an exemplary dynamic network planner and cost estimator system as the user acts on areas. A few non-limiting examples of such operations and actions include:

1. Login/Logout (with user-limited permissions)

2. Create a new project in a Market they are able to access (with appropriate permissions levels)

3. Create new area(s) within a project in a Market they are able to access (with appropriate permissions levels)

4. Load an existing (previously defined) project or area within a Market they are able to access (with appropriate permissions levels)

5. Save an existing project or area under a new/different name or into another Market this user has access to. This allows an area to be “copied”

6. Modify a project or an area and save the updates including the ability to rename the area in place (no copying)

7. Search for a project or area that has particular characteristics, e.g. a specified market or in a particular range of size, and/or with certain modifiers applied

(b) Defining the Project.

To perform network planning estimation, the user must setup at least one “project” into which coverage area(s) can be placed for coverage analysis and cost/benefit simulations. The definition of a project includes the following information:
Lookup Value: Market (composite key with Name)
Project Name (composite key with Market)
Description
Project Creator
Project Owner (Current)
Project Creation Date
Project Creation Time
Project Last Update Date
Project Last-Update Time
Project-Level Additional Equipment (complex type) (vector of values, one or more) including fields for the complex type such as equipment type and quantity.

(c) Defining Coverage Area(s):

In defining the coverage area or areas, the user must setup at least one area of coverage to be modeled in the dynamic network planner and cost estimator. The definition of a coverage area includes the following key subcategories of information:

Area Identity
Lookup Value: Market (composite key with Name)
Name (composite key with Market)
Description
Area-Level Cost Modifiers

Area Topography and General Characteristics
It should be appreciated that these coverage areas could (in some embodiments) be drawn directly on a map and be managed at actual coordinates on the globe or, the area could be defined as:
Coverage Area Width
Coverage Area Length
Coverage Area Units
Coverage Area Cost Modifiers

Residential Prospects
Residential Population
Average Consumer Characteristics (Average Age, Annual Income, Telecom Spend, Technology Attitudes) The elements of this will change over time. They are the information used by the calculations to select the most appropriate services and estimate the “take-rates” for each. Generally they are the consumer demographics and psychographics of these prospects to be covered.
Residential Service(s) (Services, Take Rate, Average Service Revenue Per Sale, Average Service Profit Per Sale) The services to be offered to consumers can be filled out in one of at least two ways: The end user can specify the services to be provided to consumers OR the system can leverage its database and estimation algorithms to predict this based on the “Average Consumer Characteristics” when they are provided. This gives the End User two ways to provide the inputs necessary to run a simulation/estimation on a project.

Commercial Prospects
Business Population
Average Business Characteristics (Average Employee Count, Annual Profit, Telecom Spend, Technology Focus) The elements of this will change over time. They are the information used by the calculations to select the most appropriate services and estimate the “take-rates” for each. Generally they are the business demographics and psychographics of these companies to be covered.
Business Service(s) (Services, Take Rate, Average Service

Revenue Per Sale, Average Service Profit Per Sale) The services to be offered to businesses can be filled out in one of at least two ways: The end user can specify the services to be provided to businesses OR the system can leverage its database and estimation algorithms to predict this based on the “Average Business Characteristics” when they are provided. This gives the End User two ways to provide the inputs necessary to run a simulation/estimation on a project.

Additional Equipment

(d) Calculations/Simulations

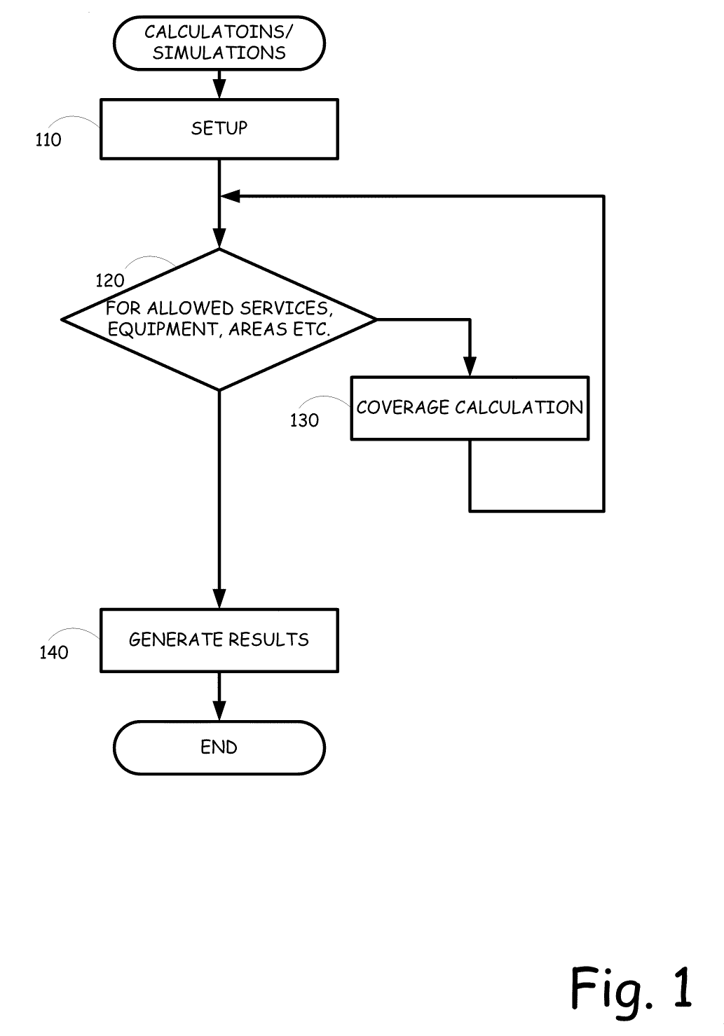

Once an end user has established a project and configured a group of one or more coverage areas within the project, a calculation/simulation routine can be run. FIG. 1 is a flow diagram illustrating general steps that may be performed in an exemplary embodiment of a calculations/simulations routine. Initially the end user goes through a setup process 110. In some embodiments the function of running a “coverage projection” is offered. For each area, the coverage projection can iterate through each piece of coverage equipment, each area and/or sub-area, and each set of potential service offerings configured in the system. However, in the setup process, the user can confine the “search space” at any level of these calculations. This is done by the user being able to de-select services to consider offering, equipment (by type, vendor or model) or de-select any whole coverage areas in the project. In some embodiments, the user may also be able to identify preferred services and/or equipment, sets or categories of preferred services and/or equipment, or to associate a weighting or priority of selection with the various services and/or equipment.

Once the setup process is completed, for the allowed services, equipment, areas, etc., in the configurations identified by the user 120, the coverage calculation process 130 is executed. Once the coverage calculation process 130 is completed, the results are generated 140 and provided to the user.

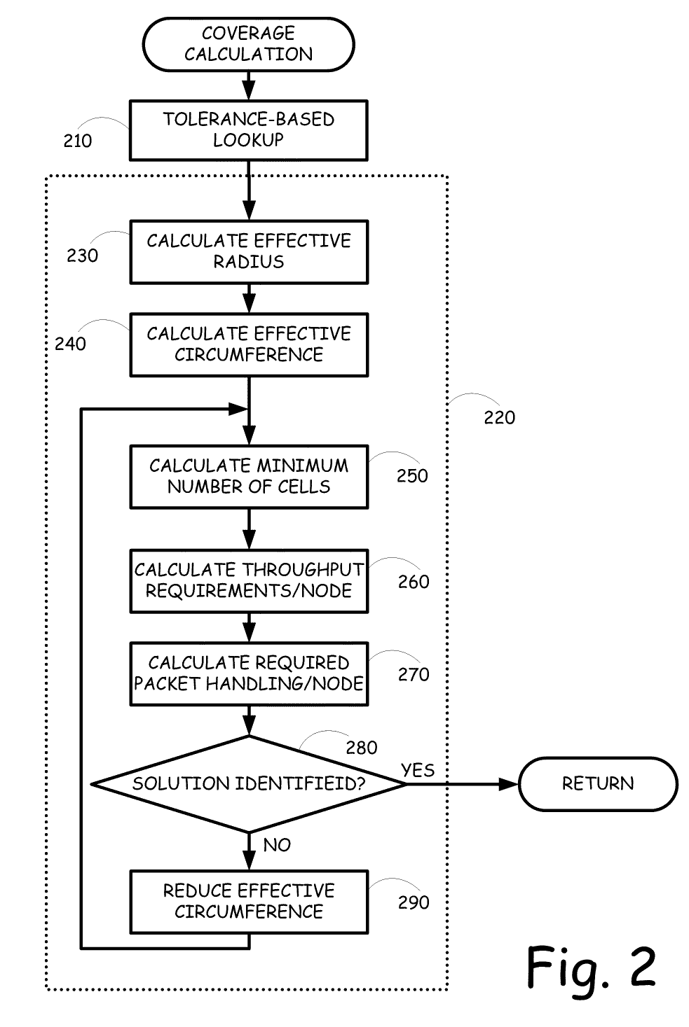

For each collection of services, technology, and piece of coverage equipment left in the simulation in each area under consideration, the coverage calculation 130 is performed. FIG. 2 is a flow diagram of exemplary steps performed in an exemplary coverage calculation algorithm that can be employed within an exemplary dynamic network planner and cost estimator system.

If the services to be offered (for residential customers, business customers, or both) have not been fully specified, then the dynamic network planner and cost estimator system will select them automatically and appropriately so that the coverage calculation algorithm can proceed. For instance, in some embodiments a default set of services, equipment etc. may be utilized and in other embodiments, various configurations may be selected based on already entered or known information.

Various algorithms may be used for coverage calculation process and the algorithm used to appropriately select these services can be interchangeable in the system as a “plug-in” or can be a dedicated algorithm, or even an algorithm that can operate differently based on input parameters. In an exemplary embodiment appropriate service mixtures are identified—complete with take-rates, costs, and pricing—by employing a “tolerance-based lookup” 210 from an empirical database using the key values contained in the project and coverage area including: market, residential and business population characteristics (range of incomes, telecom spends, percentage of early adopters, etc.) and return the services where this population satisfies the tolerances for effective sale of these offerings.

Next the coverage calculation algorithm 130 calculates the number of devices that would be required for a given technology, vendor, and model 220 to cover a defined area. A goal in some embodiments is to maximize the coverage within the area while minimizing overlap, as well as cross channel interference, etc. This calculation can be performed using a pluggable module so that the module can be replaced with better methods in the future.

Calculating the number of devices required first includes calculating transmitting and receiving footprint for a given piece of equipment based on the technical specifications loaded into the equipment database by the Technology Administrators. Once this is determined, then the number of pieces of equipment to cover that area can be determined. One technique to accomplish this is by calculating the “effective radius” for the piece of equipment by taking its reach radius and knocking off or subtracting the overlap percentage 230. In addition, the process includes calculating the “effective circumference” for the piece of equipment by multiplying the “effective radius” by a factor of two (2) 240. (Of course, some very new technologies for telecommunications such as beam forming are creating non-circular patterns of coverage. Embodiments of this invention can plug in alternative algorithms to calculate transmit/receive footprints of arbitrary shapes or footprints that may have coverage gaps.)

Next, the process continues by calculating the “minimum number of footprints”, often referred to a “cells”, to cover an area 250. Calculating the minimum number of cells to cover an area 250 involves several additional steps. One such step involves calculating the “column-count” as ceiling of a particular area's width (i.e., effective circumference). Next, the process operates by calculating “row-count” as a ceiling of an area's length (i.e., effective circumference). In this exemplary process, the minimum number of cells is then determined as a rounded figure of the column-count multiplied by the row-count.

At step 260, the “throughput requirements per node” are calculated. This calculation is performed by looking at each residential service area and each business service area.

For each residential service in the area, the residential-subscriber-count is calculated by multiplying the residential population with a take rate for a given service. Then, the residential-required-throughput is calculated by multiplying the residential-subscriber-count with the throughput requirement for this service and then multiplying this product with the oversubscription factor for this service.

For each business service in the area, the business-subscriber-count is calculated by multiplying the business population with a take rate for a given service. Then, the business-required-throughput is calculated by multiplying the business-subscriber-count with the throughput requirement for this service and then multiplying this product with the oversubscription factor for this service.

Finally, the throughput requirement per node is determined as the sum of the residential and business required throughputs divided by the minimum number of cells.

At step 270, the “required packet handling per node” is calculated as the sum of the Packets Per Second (PPS) for each service being deployed (residential and business), multiplied by the oversubscription factor.

At decision block 280, the process determines if a solution has been identified. A solution has been identified if and only if the “throughput requirements per node” are less than the throughput capacity for the device AND the “required packet handling per node” is less than the packet-handling capacity of the device. If a solution is identified, then the coverage calculation algorithm is exited and processing continues at step 140 (see FIG. 1) of the calculations/simulations process. As such, if all processing is completed, then the results or the answers are displayed to the user for this area and for this coverage equipment.

If at decision block 280 it is determined that a solution is not generated within range of the equipment both in terms of throughput and in terms of packet handling, then the algorithm operates to reduce the “effective circumference” down to a level where it does work 290 (i.e, more of this particular type of piece of equipment needs to be used, such as more APs or base stations). In an exemplary embodiment, the effective circumference is reduced using a midpoint strategy. For example, if the radius is too large, it is halved. After reducing the effective circumference, processing returns to step 250 with the lowered value for “effective circumference” that works and those answers based on the largest “effective circumference” that satisfies the equipment capacity are displayed to the user.

Returning to step 140 in FIG. 1, upon completion of the processing, results illustrating the total capacity requirements that have been calculated for this coverage area are generated. This may include displaying the results to a user or feeding the results into an automated system for processing. That would be the “throughput requirements per node” and the “required packet handling per node” as well as the number of nodes of each equipment types since this will be used for distribution network and backbone planning.

(e) Additional Coverage Capabilities

Coverage areas in exemplary embodiments of the dynamic network planner and cost estimator can be defined using rectangular shapes. In such embodiments, this shape is chosen to keep interaction with the tool simpler for the system user. However, it should be appreciated that a rectangular shape coverage area is not a requirement or limitation of the various embodiments. By employing more technical sophistication on the part of the user, then embodiments could allow users to draw coverage areas of arbitrary shapes by plugging in new algorithms to calculate their area and calculate coverage. The various examples that are presented herein focus on the use of rectangular areas to simplify the description.

Aggregation of (More Refined) Coverage Areas

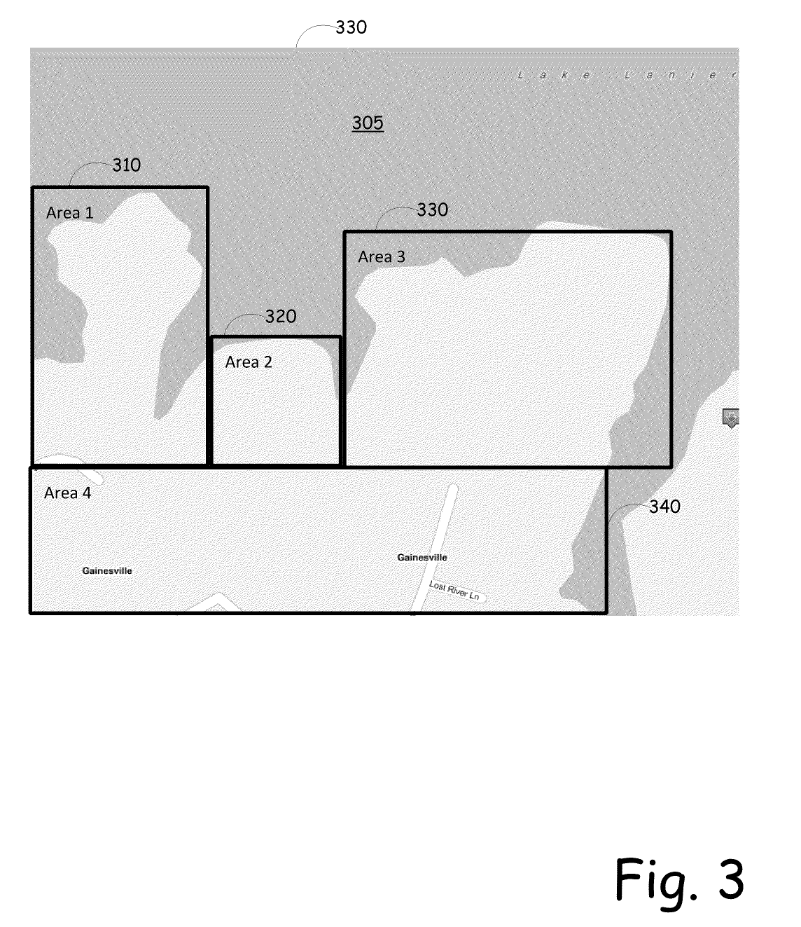

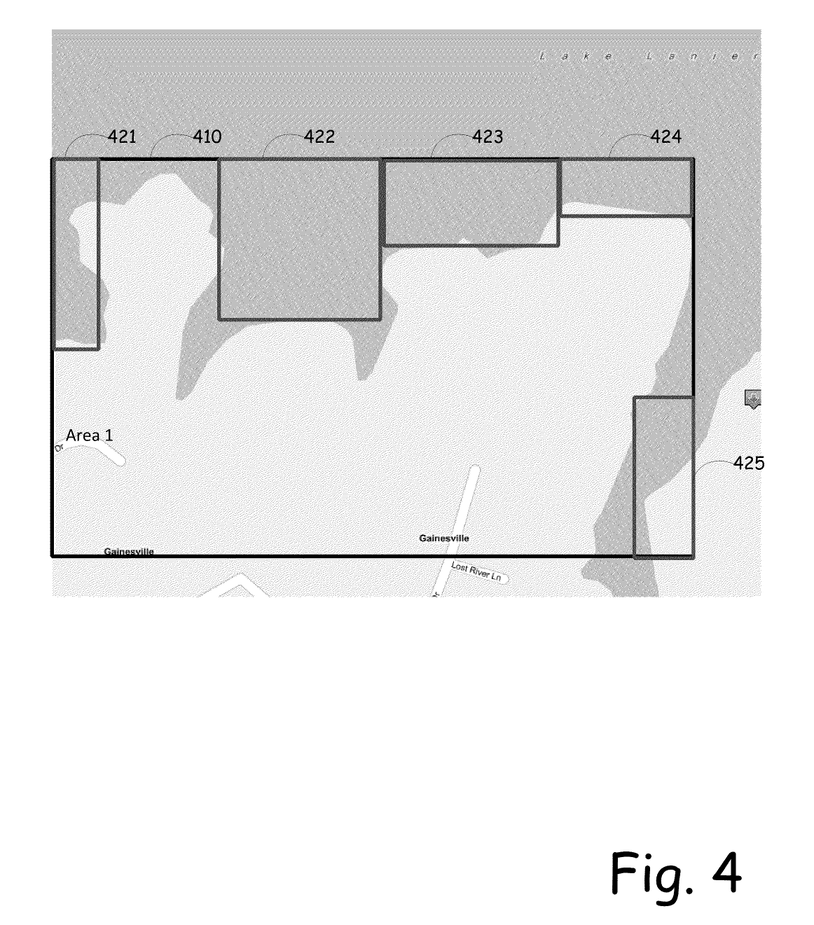

FIG. 3 is a map diagram illustrating the operation of an exemplary aggregation operation in an embodiment of the dynamic network planner and cost estimator system. For this example, the reader should assume that the coverage area 300 is large with a lake 305 contained within area. Connectivity to the area covered by the lake is not necessary or required, and therefore, equipment will not be allocated to the lake area to avoid wasting valuable resources. Further it should be assumed that the populations in the various areas around the lake have differing demographics and network service needs. One straight forward solution is to break that network into multiple areas that an exemplary system will aggregate into the final result.

FIG. 3 illustrates four (4) areas of coverage 310, 320, 330 and 340 with each area of coverage having different service and coverage needs and which are adjusted to minimize the waste over the water. This aggregation of more refined coverage areas allows the end user to:

(i) Separate out areas that have divergent types of subscribers, subscriber demographics, and service needs;

(ii) Avoid wasting coverage in areas that are not likely to produce revenue; and

(iii) Stick with relatively simple shapes for coverage areas that are easier to draw, manage, and align (side to side and top to bottom).

In an exemplary embodiment, this tool is fully integrated onto a mapping engine so that the end user can zoom in and out and draw their coverage areas more accurately. Maximum and minimum bounds on the zoom level and sizes for these coverage areas can be managed with the tuning parameters for the system described earlier.

Coverage Exclusion Areas

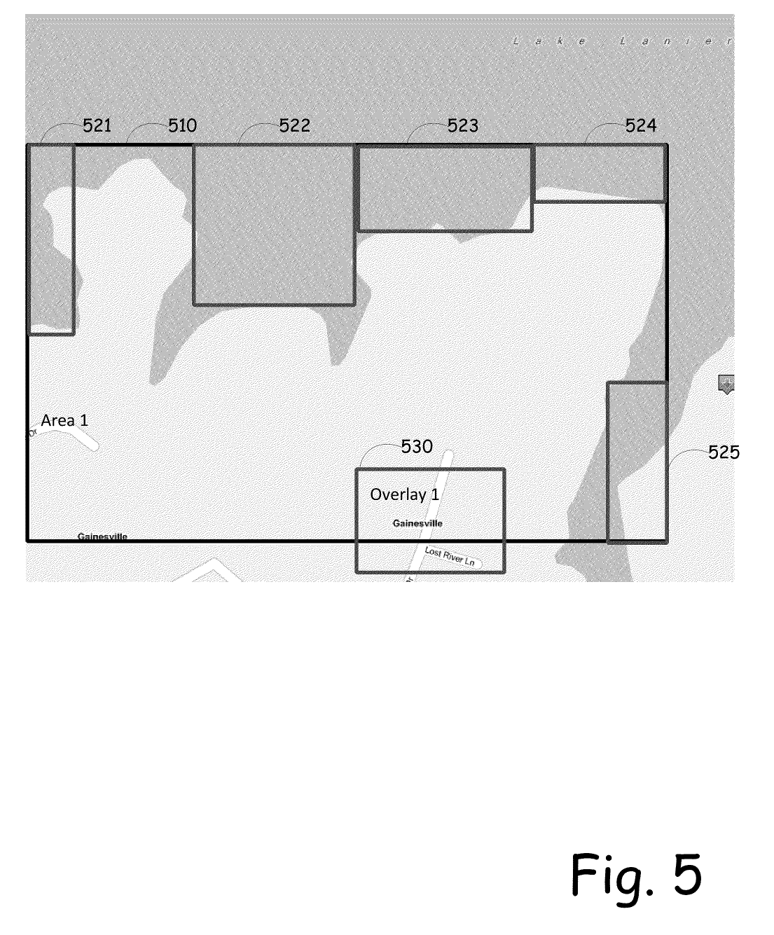

In some embodiments, an alternative method for avoiding wasted coverage is available when the subscriber demographics and service needs are similar or uniform across an area. FIG. 4 is a map diagram illustrating an exemplary technique for coverage exclusion for an area with uniform demographics and service needs. In such a situation, an area such as Area 1 410 having uniform demographics and services needs, the user is only required to identify non-overlapping areas for coverage exclusion. IN the illustrated example, the non-overlapping areas of coverage exclusion may be defined as illustrated in FIG. 4. Several boxes 421, 422, 423, 424 and 425 are used to indicate areas of coverage exclusion. The actual result of defining the areas of coverage exclusion is the reduction of the area of coverage for Area 1 by the sum of the areas of exclusion indicated by the boxes 421-425 as it provides the estimates. In some embodiments, the following rules can be enforced by the system in the creation and placement of these areas of coverage exclusion:

1. The areas be fully contained in a single coverage area

2. The areas must not overlap any other areas of exclusion

Overlays

Some embodiments of the dynamic network planner and cost estimator system support networks designed with an overlay strategy, because overlays are often key to building an effective network. The general idea of overlaid coverage areas is that there are two distinct types of subscriber demands that at least partially overlay one another on the map. For example, we may have a pocket of very high bandwidth business users in a pocket that partially overlays (or is completely contained within) a residential coverage area. We indicate this to the tool by overlaying an additional coverage area which may have distinct service needs right on top of the previous coverage area(s). The system will then design two (at least partially overlapping) coverage networks with different criteria and potentially different technologies, vendors, equipment, and distribution and/or backhaul.

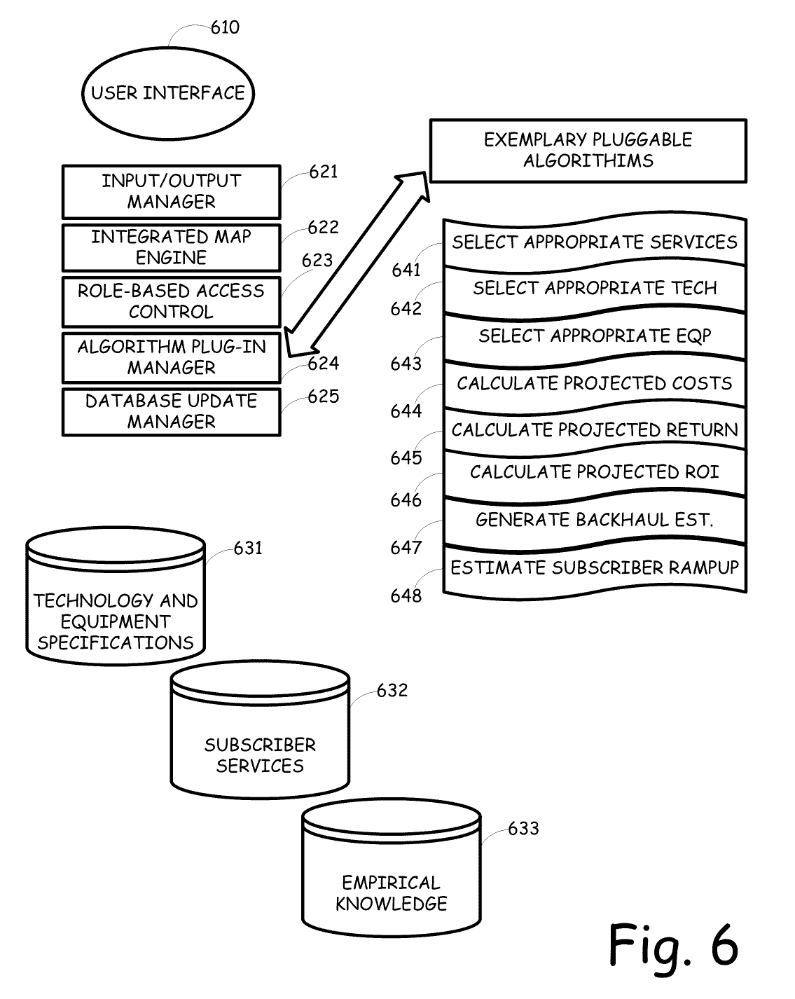

FIG. 5 is a mapping diagram illustrating how the overlay feature may appear on a mapping interface. One primary area (Area 1) of coverage is illustrated 510 with a few areas of exclusion 521-525. One overlay area 530 that partly overlaps the primary coverage area 510 but also extends a bit below and out of the primary coverage area 510 is illustrated. In operation, an exemplary embodiment will generate the service and equipment needs separately for the primary coverage area(s) 510 and the overlay(s) 539. Note, to further clarify the operation, if there were no overlap, then the overlay is simply another coverage area with differing subscriber requirements.

(f) Distribution and Backbone

Upon completion of the above-identified processes, the total capacity and Packets per Second (PPS) that need to be distributed throughout this area are known. At this point, an exemplary embodiment of the system can generate the total number of each type of backhaul equipment that are required or that can be utilized to bring the right capacity into the coverage areas. This, however, is a complicated process due to the fact that there are many backhaul options and the lengths of these connections need to be considered as well as how they may have to be chained together to reach out into a coverage area. In an exemplary embodiment, a “best fit” approximating process can be utilized, however, in other embodiments it is anticipated that an algorithm can be utilized for executing the installation of the “best fit” services, technologies, and equipment modeled in the compute environment in the real world.

In exemplary embodiments, two methods of approximation for the distribution and backhaul may be implemented, although as indicated, more techniques may also be employed. The first method is an “automatic” estimation and the second method is a “user-guided” estimation.

In either of the disclosed methods, the setup process is the same. The user indicates the available/accessible primary bandwidth injection points that will be used by both location (where they are) and capacity (how much bandwidth can be procured from this point). These primary injection points may be quite diverse: fiber fed from undersea cable, satellite links, etc.

Automatic Estimation

In an embodiment providing automatic estimation, the system operates to automatically “grow” the high-speed backbone and distribution links off of that backbone from each primary injection point through to evenly spaced redistribution points. An option that can be provided is to instruct the system to bring in additional capacity for growth, to reduce latency, or for other reasons. This need can be indicated by a parameter that specifies a request to increase the bandwidth brought in to 150%, 200%, 300%, etc. of the current estimated need.

In the automated estimation method, the user is allowed to specify if the system should:

(a) optimize for fewest links; and/or

(b) optimize for lowest equipment cost.

This parameter is useful as a guide (and others may also be identified and implemented in other embodiments) because these backhaul links tend to have the following tradeoff: the cost to implement is less expensive if a more distributed design (e.g. more links/paths of lower capacity) is allowed, with a tradeoff of experiencing some increase in the overall operational costs to manage them.

User-Guided Estimation

In an embodiment providing user-guided estimation, the user is allowed to “lay pipe” graphically on the map and at each point select the type of link to be used. Thus, a graphical user interface allows a user to select the type of link and identify the connection points for that link. Some embodiments may provide immediate corrective feedback in the event that these links are extended beyond their range capabilities (i.e., asked to carry more capacity than the technology allows, etc.)

Validations

For either case, the various embodiments can operate to validate the backhaul and distribution strategy based on the information provided by the Administrators as they configure and update over time the properties of these backhaul technologies and equipment. In an exemplary embodiment, the validations may include:

(a) the range for each link;

(b) the capacity for each link; and/or

(c) “Chaining” considerations for links.

Chaining consideration for the links means that:

(a) when one higher bandwidth link is split into multiple links to allow for the redistribution of the bandwidth, the capacities of the smaller links summed together do not exceed the capacity of the faster link aggregating them.

(b) when links of two different types are chained together, the expectation of throughput immediately becomes the lesser of the two across the composite link.

(c) there is an overall distribution of capacity (i.e. that there is sufficient bandwidth available to each node in the coverage area to backhaul its traffic up to the higher levels of the network).

It should be noted that in the event that overlays are utilized in an embodiment, each “layer” gets its own backhaul plans and costs separate from the overlaid coverage area(s). However, in some embodiments, an algorithm can be utilized that considers sharing backhaul between layers in the same geography.

(g) Cost/Benefit Analysis and ROI

Once this simulation/analysis is complete, an exemplary system may operate to produce a wide range of additional but very valuable calculations for the user. Having knowledge of the predicted number of subscribers (both residential and business), the service mixes they are expected to contract for, and the amounts they will pay per service, additional calculations can be performed. On the cost side, it is known what the cost is for setting up each instance of each service and the amounts of anticipated spending to maintain them over time. Thus, the gross profits from each service can be calculated. This information is then sufficient to project the total revenue and profit by service, by coverage area, by subscriber type (residential or business), and by subscriber.

Additionally, the predicted number of units for each piece of equipment for each coverage area, along with the initial acquisition prices, expected logistics and other costs, and the ongoing operating expenses is known. This information is sufficient to project the costs to build the network out and to operate it each month thereafter.

Finally, this information can be combined to show a cash-flow model for the network, however, one more bit of information is required. The manner in which the subscribers will “ramp up” needs to be modeled because it is not realistic to assume they all sign up on the first day for all services. At least two methods can be used to acquire this information. In one method, an embodiment of the system leverages a pluggable algorithm that has access to historical information to automatically estimate the “ramp up”. In another method, the system simply allows the end user to indicate—for each service type—how many (or by a percentage) of the estimated subscribers will take advantage of the service in month 1, month 2, etc. This needs to be expressed as “net new” adds since adding 100 new users when 50 drop their service results in only 50 “net new” adds—the number that is truly relevant with regards to subscriber ramp-up.

Applications for Exemplary Embodiments

There are many applications for the various embodiments of the dynamic network planner and cost estimator. A breadth of applicability for the various embodiments is obtained by the employment of three areas of flexibility being incorporated into the various embodiments. These areas of flexibility include:

1. Updating/evolving the stored data that drives all of the calculations (via the Technology and Cost Administrative logins) as new equipment and technologies become available or as cost realities change

2. Adding new object-types to describe coverage elements or adding in new object-types for a new type of coverage planning (i.e. “non-network” coverage), such as camera coverage for video surveillance.

3. Plugging in different or extended algorithms for calculation at each of the key points:
a. Selection/Calculation of the most appropriate service option(s)
b. Selection/Calculation of the most appropriate technology option(s)
c. Selection/Calculation of the most appropriate vendors and equipment type(s)/model(s)
d. Calculation of the projected costs
e. Calculation of the projected revenues and profits OR other benefits. It is important to note that this can be any value equation (not just a financial one). For example, in a medical application we could measure “return” as number of prevented cardiac events or in security applications we could measure “return” as the number and severity of terrorist episodes that were prevented.
f. Calculation of the projected returns on investment, again where “return” need not always be measured in dollars. (We could generate an ROI in other terms such as in “aborted terrorist attacks per dollar invested” or “lives saved per dollar invested”.)
g. Calculation of the backhaul—in automated mode
h. Calculation of the service “ramp up”—in automated mode

These flexibilities are beneficial in that the various embodiments can be used in the technology space where technologies, vendors, equipment, capabilities, and total cost (acquisition, logistics, maintenance, etc.) change frequently.

In essence, the various embodiments allow for the leveraging of automation to select from technical options, generate a coverage plan (for all the valid, candidate options), estimate costs, calculate returns, and evaluate the benefits returned from the execution of the particular—recommended—technology coverage plan(s) in real-time by leveraging the computational advantages of the computer to ensure far more accuracy and thoroughness than one or more human analysts could perform—certainly in the same amount of time and typically in orders of magnitude more time.

The various embodiments can be deployed in a variety of potential applications, including but not limited to the following non-limiting examples:
Surveillance network planning (planning coverage, cost, benefit, and ROI for CCTV and other technology-based surveillance service applications)
Sensor network planning (planning coverage, cost, benefit, and ROI for systems that monitor sensors/detectors of any technically measurable values such as temperature, radio frequencies, humidity . . . )
Nanotechnology applications (planning coverage, cost, benefit, and ROI for deploying a calculated number of “nano-bots” or other tiny technical devices over an area to perform a value-generating capability such as repairing cellular damage.)
General medical applications (planning coverage, cost, benefit, and ROI for new lighting systems that may destroy bacteria in the air as one example)
Satellite coverage planning (planning coverage, cost, benefit, and ROI for new satellite service deployments)

### Alternative Embodiments

There are a great number of extensions and minor modifications that can be incorporated into the various embodiments. A few non-limiting examples include the following.

Parallel computation. Parallel computation can be used to allow a machine with multiple processing elements or multiple computers connected via a network to perform the functions listed for the various embodiments more quickly. This may have the added advantage of allowing the system to run additional “What-if” analyses (i.e. testing more options defined by the data in the database) that could not all be run on a single processor computing device. It is noted that advancements in hardware and operating system technologies will allow the various embodiments to take advantage of parallel processing with little to no software changes because those hardware and operating system combinations can automatically and transparently distribute the workload across processors.

Plug-in Expansion. Through the ability to plug in new calculation/simulation algorithms, there are a number of alternative embodiments that can exist now and/or expand to in the future. These expansions include, but are not limited to:

(a) Various flavors of Artificial Intelligence (AI) to perform the calculations in different ways and likely with less support/input from the users.

(b) Various flavors of Data Mining to perform the calculations based even more directly on empirical data. The current embodiment allows the administrative users to update all of the information that drives the coverage planning, costing, and benefit estimation. But a future algorithm, based on data mining, could conceivably identify and update those values on its own.

(c) Various flavors of what is known as “Evolutionary Programming” could be employed, particularly in the face of our growing parallel processing power, to “evolve” the calculations over time automatically—much as biological evolution has allowed natural selection in biological organisms.

Portability. Advantageously, embodiments can exist within a hand-held or other portable devices thereby allowing users to generate the most effective technology coverage plans anywhere they are and anytime they are needed. In these alternative embodiments, the portable device capabilities can be leveraged to ease input, e.g. leveraging the camera on a portable telephone to take a picture of a new device from which Optical Character Recognition (OCR) reads the vendor and model number allowing the system to automatically access the vendor's website for the technical specifications of this device which are loaded into the system in real-time. Similar benefits can be found in output, e.g. the device using Text to Speech (TTS) technology to verbally describe the ROI analysis for each option through the phone or other portable device's speakers.

Evaluation of other plans. The various embodiments may be used not only to generate new coverage plans, but also to evaluate technology coverage plans designed by other entities (systems or people) by their cost, benefit, and ROI. This is achieved by inputting the externally created plans and leveraging the existing algorithms and databases.

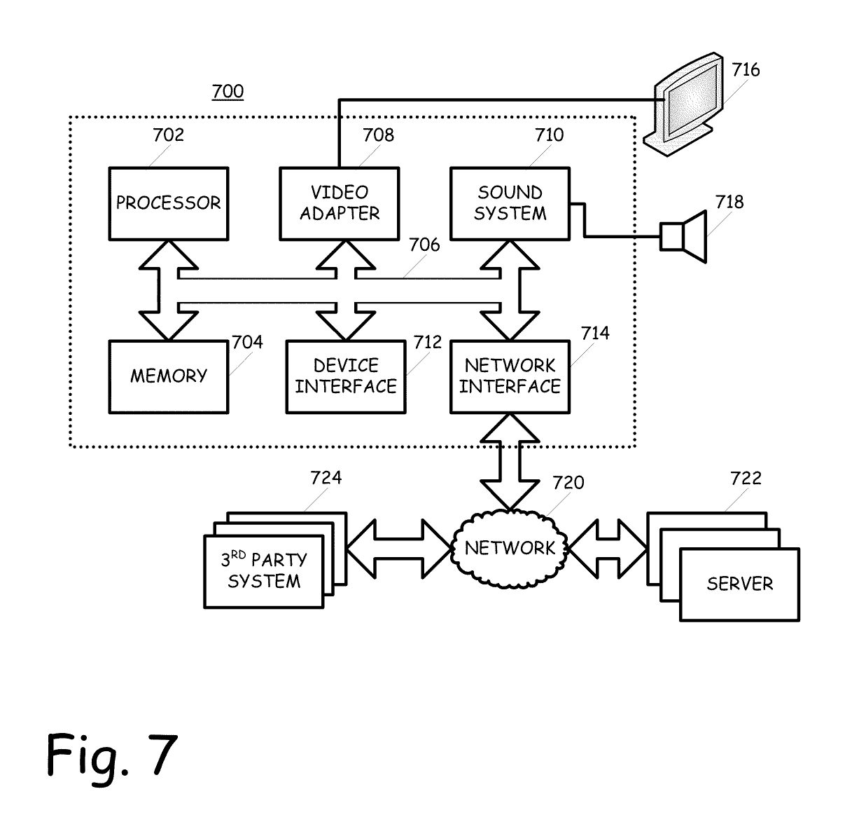

FIG. 6 is a block diagram illustrating a functional breakdown of various components and functions in an exemplary embodiment of a dynamic network planner and cost estimator. A user interface, such as a dedicated user interface on a local application or a browser interface such as for a networked or web based application 610 is presented to the user. The user interface gives the administrative and/or end users access to the following components based on permissions:

The input/output manager 621;

The Integrated Map Engine 622;

The Role-based access control 623;

The algorithm plug-in Manager 624; and

The Database update manager 625.

The typical embodiments include various databases or information sources/repositories. FIG. 6 illustrates a functional breakdown of three types of information that is accessible to the system. It should be noted that this information can be stored locally on the system, accessible on local networks or available over wide area networks. In addition the data may be spread over a variety of locations and sources. The illustrated categories include technology and equipment specifications 631, subscriber services 632 and empirical knowledge 633. The technology and equipment specifications can include information obtained either previously or in real time from the manufactures website or repositories. The subscriber services identify the services that are available for the various telecommunication networks. The empirical knowledge is updated and reflective of past designs and experiences as well as network performances.

The algorithm plug-in manager 624 has access to a variety of pluggable algorithms or, enables the downloading or inclusion of various pluggable algorithms 640. A few exemplary algorithms include:
(a) selecting appropriate services 641;
(b) selecting appropriate technology 642;
(c) selecting appropriate equipment 643;
(d) calculating projected costs 644;
(e) calculating projected return 645;
(f) calculating projected ROI 646;
(g) generating backhaul estimations 647; and
(h) estimating subscriber ramp up 648.

FIG. 7 is a general block diagram illustrating a hardware/system environment suitable for various embodiments or embodiments of components of the dynamic network planner and cost estimator. A general computing platform 700 is shown as including a processor 702 that interfaces with a memory device 704 over a bus or similar interface 706. The processor 702 can be a variety of processor types including microprocessors, micro-controllers, programmable arrays, custom IC's etc. and may also include single or multiple processors with or without accelerators or the like. The memory element 704 may include a variety of structures, including but not limited to RAM, ROM, magnetic media, optical media, bubble memory, FLASH memory, EPROM, EEPROM, etc. The processor 702 also interfaces to a variety of elements including a video adapter 708, sound system 710, device interface 712 and network interface 714. The video adapter 708 is used to drive a display, monitor or dumb terminal 716. The sound system 710 interfaces to and drives a speaker or speaker system 718. The device interface 712 may interface to a variety of devices (not shown) such as a keyboard, a mouse, a pin pad, and audio activate device, a PS3 or other game controller, as well as a variety of the many other available input and output devices. The network interface 714 is used to interface the computing platform 700 to other devices through a network 720. The network may be a local network, a wide area network, a global network such as the Internet, or any of a variety of other configurations including hybrids, etc. The network interface may be a wired interface or a wireless interface. The computing platform 700 is shown as interfacing to a server 722 and a third party system 724 through the network 720.

In the description and claims of the present disclosure, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit”, “routine” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The various embodiments have been described using detailed descriptions that are provided by way of example and are not intended to limit the scope of the invention. The described embodiments comprise different features, not all of which are required in all embodiments. Some embodiments utilize only some of the features or possible combinations of the features. Variations of embodiments that are described and embodiments comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A system for providing a dynamic network planning and cost estimation for the same, the system comprising:
a user interface configured to allow an administrative user access and end user access;
a memory element for receiving definition data from an administrative user, the definition data including technology specifications, equipment specification and subscriber services definitions;
a calculation simulator configured to receive a coverage area definition and, in response thereto:
extract applicable configuration data from memory element based at least in part on the coverage area definition;
for each applicable equipment type, calculating the number of pieces of the equipment required to cover the coverage area;
identify the data throughput requirements for each node in the coverage area;
identify the required packet handling for each node in the coverage area; and
determine whether the throughput requirements for each node are less than the throughput capacity for the particular equipment type and whether the required packet handling per node is less than the packet-handling capacity of the particular equipment type, and if so calculate the cost of the network based at least in part on the number of required pieces of the particular equipment type and the costs associated with that particular equipment type.

2. The system of claim 1, wherein the user interface is configured to enable an end user to identify services and equipment that can be used in the simulation.

3. The system of claim 1, wherein the user interface is configured to enable an end user to identify services and equipment that are excluded from the simulation.

4. The system of claim 3, wherein the calculation simulator is configured to extract applicable configuration data including what services to be offered.

5. The system of claim 1, wherein the calculation simulator is configured to calculate the number of pieces of the equipment required to cover the coverage area by:
calculating an effective radius for a particular piece of equipment;
calculating an effective circumference for the particular piece of equipment; and
calculating a minimum number of cells to cover the coverage area based on the number of columns and rows required in view of the effective circumference.

6. The system of claim 1, wherein the calculation simulator is further configured, if the throughput requirements for each node are not less than the throughput capacity for the particular equipment type and/or, the required packet handling per node is not less than the packet-handling capacity of the particular equipment type, then decrease the effective circumference and continue at the step of calculating the number of pieces of the equipment required to cover the coverage area with the reduced effective circumference.

7. The system of claim 6, wherein the user interface is further configured to allow an end user to identify excluded areas within the coverage area to excluded from the simulation by providing a graphical interface on which an end user can select excluded areas.

8. The system of claim 6, wherein the user interface is further configured to allow an end user to identify overlay areas that cover at least a portion of the coverage area by providing a graphical interface on which an end user can select an overlay area.

9. A method for dynamic network planning and cost estimation, the method comprising the steps of:
receiving definition data from an administrative user, the definition data including technology specifications, equipment specification and subscriber services definitions and storing the date into a memory element;
receiving a coverage area definition from an end user;
based on the coverage area definition, extracting applicable configuration data from the memory element;
calculating the number of pieces of each type of equipment required to deploy a network that fully services the coverage area;
identifying the data throughput requirements for each node in the network;
identifying the required packet handling for each node in the network; and
calculating the cost of the network based at least in part on the number of required pieces of the particular equipment type and the costs associated with that particular equipment type if the throughput requirements for each node in the network are less than the throughput capacity for the particular equipment type and, the required packet handling per node is less than the packet-handling capacity of the particular equipment type.

10. The method of claim 9, further comprising the step of receiving the identity of services and equipment that can be used in the simulation.

11. The method of claim 10, wherein the step of extracting applicable configuration date further comprises identifying services to be offered.

12. The method of claim 10, wherein the step of extracting applicable configuration date further comprises identifying services to be offered based on the demographic data previously obtained for the coverage area.

13. The system of claim 12, the step of calculating the number of pieces of each type of equipment required to deploy a network that fully services the coverage area further comprises:
calculating an effective radius for a particular piece of equipment;
calculating an effective circumference for the particular piece of equipment; and
calculating a minimum number of cells to cover the coverage area based on the number of columns and rows required in view of the effective circumference.

14. The method of claim 13, wherein if the throughput requirements for each node are not less than the throughput capacity for the particular equipment type and/or, the required packet handling per node is not less than the packet-handling capacity of the particular equipment type, then further comprising the step of decreasing the effective circumference and continuing at the step of calculating the number of pieces of the equipment required to cover the coverage area with the reduced effective circumference.

15. The method of claim 14, wherein the step of receiving a coverage area definition from an end user further comprises receiving excluded areas within the coverage area to excluded from the simulation.

16. The system of claim 15, wherein the step of receiving a coverage area definition from an end user further comprises receiving overlay areas that cover at least a portion of the coverage area.

17. A system for providing a dynamic network planning and cost estimation for the same, the system comprising:
a user interface configured to allow an administrative user access and end user access;
a memory element for receiving definition data from an administrative user, the definition data including technology specifications, equipment specification and subscriber services definitions;
a calculation simulator configured to receive a coverage area definition including excluded areas and, in response thereto:
extract applicable configuration data from memory element based at least in part on the coverage area definition;
for each applicable equipment type, calculating the number of pieces of the equipment required to cover the coverage area by:
calculating an effective radius for a particular piece of equipment;
calculating an effective circumference for the particular piece of equipment; and
calculating a minimum number of cells to cover the coverage area based on the number of columns and rows required in view of the effective circumference;
identify the data throughput requirements for each node in the coverage area;
identify the required packet handling for each node in the coverage area; and
determine whether the throughput requirements for each node are less than the throughput capacity for the particular equipment type and whether the required packet handling per node is less than the packet-handling capacity of the particular equipment type, and if so calculate the cost of the network based at least in part on the number of required pieces of the particular equipment type and the costs associated with that particular equipment type, and if not decrease the effective circumference and continue at the step of calculating the minimum number of cells with the reduced effective circumference.

18. The system of claim 17, wherein the user interface is configured to enable an end user to identify which services and equipment that can be used in the simulation.

19. The system of claim 17, wherein the calculation simulator is configured to extract applicable configuration data including what services to be offered.

20. The system of claim 17, wherein the user interface is further configured to allow an end user to identify overlay areas that cover at least a portion of the coverage area by providing a graphical interface on which an end user can select an overlay area.
